(19) United States
(12) Patent Application Publication
(10) Pub. No.: US 2012/0030919 A1
(43) Pub. Date: Feb. 9, 2012

(54) DEVICE AND METHOD FOR PLACING A SLIDER ON A BAG WITH CLOSURE PROFILES

(75) Inventors: Antony Roger, Thouare-sur-Loire (FR); Michel Barreaux, Henonville (FR)

(73) Assignee: S2F FLEXICO, Henonville (FR)

(21) Appl. No.: 13/145,524

(22) PCT Filed: Jan. 14, 2010
(86) PCT No.: PCT/EP2010/050373

§ 371 Date: Sep. 16, 2011

(30) Foreign Application Priority Data
Jan. 21, 2009 (FR) 0950359

(51) Int. Cl. B23P 11/00; B23P 19/00

(52) U.S. Cl. 29/428; 29/700

(57) ABSTRACT

The invention particularly relates to a device for placing a slider (1) for actuating closure profiles (P₁, P₂) of a bag (S), that includes a base, two flanges, and means adapted for respectively urging said closure profiles (P₁, P₂) towards each other or away from each other on a bag (s), wherein said device includes at least one clamp for retaining the profiles (P₁, P₂) as well as means for urging a slider (1) towards means (5) for temporarily spacing the flanges of the slider (1), said spacing means including cam paths with a rising slope, characterised in that said means include stowable cams (5) that, in a first non-stowed position interact with said slider (1) so that, during a movement thereof, the inner surface of its flanges is brought into contact with the cam paths progressively moving the same away from each other, and that, in a second stowed position, no longer interact with the slider (1) so that said flanges are brought together.

The present invention concerns the field of bags provided with mating closure profiles actuated by a slider.

It more particularly concerns a device and method for placing a slider on a bag with mating closure profiles.

French patent 07 59545, filed on 4 Dec. 2007 to the present applicant, describes a device and method for positioning a slider on a bag with closure profiles, this slider being provided with urging lugs projecting from its sidewalls, in the vicinity of the ends thereof opposite its base, in order provisionally to open the slider and facilitate its engaging onto the closure profiles when demand is placed on the lugs.

This technique generally gives satisfaction.

However, the vast majority of sliders available on the market are devoid of such lugs, which means that the solution described in this patent application cannot be applied thereto.

In addition, a device for positioning sliders is known from document U.S. Pat. No. 6,161,271 which makes use of a carousel. A slider is placed in housing and a pin acts on the base thereof so that it is ejected. The edges of the slider come into contact with abutments of triangular shape slidingly mounted along diverging guide walls. As the slider moves, its wings push the abutments which force the free ends of the bag to come together.

The present invention sets out to remedy the shortcoming set forth above by proposing a device and method which allow the positioning of a slider on a bag with closure profiles, this slider being devoid of said projecting urging lugs, without having recourse to a carousel whose structure and functioning by definition are complicated.

Therefore, according to a first aspect, the present invention relates to a device for mounting a slider to actuate closure profiles, in particular for a closure assembly fitted to a bag, which comprises a base, two sidewalls or flanges and means adapted respectively to urge said closure profiles to draw together or to draw away from each other depending upon the direction of travel of the slider along the profiles, so as to move the profiles between an engaged closed position and a separated open position, on a bag with mating closure profiles or on an assembly of mating closure profiles, this device comprising at least one clamp to hold the profiles in stable position and means for pushing the slider towards means for provisionally drawing apart said flanges of the slider with a view to causing it to cooperate with said profiles in stable position, these drawing-apart means comprising cam paths with rising slope.

According to the invention, said means are composed of retractable cams which, in a first non-retracted position, interact with said slider so that during its travel the inner face of its flanges comes into contact with the cam paths so as gradually to draw them apart, and which in a second retracted position no longer interact with said slider so that said flanges are drawn close to one another,

the changeover from the first to the second position taking place by contact of the base of said slider with said cams, during the travel of the said slider.

From the foregoing, it will be understood that the changeover from the first to the second position of the cams occurs simply during the movement of the slider when its base comes into contact with said cams.

It is therefore the sliding or relative movement of the slider relative to the cams which causes retraction thereof.

According to other advantageous, non-limiting characteristics of this device:
the said cams are cams with pivoting axis, the changeover from the first to the second position occurring by pivoting around this axis;
the said axis extends over a plane generally parallel to the plane in which the base of said slider is contained;
it comprises means for retaining said cams in said first position, holding them in this position for as long as the base of the slider is not contact therewith;

the said retaining means are composed of springs;
the said cams have one bevelled face, the changeover from the first to the second position taking place by wedge effect when said base of the slider comes into contact with this bevelled face;
it comprises two pairs of cams, each pair being positioned to come into contact with one same flange of said slider;
said pairs are separated by a positioning gap for said profiles;
it comprises at least one abutment for immobilising the said profiles,
it comprises a pair of abutments, each being positioned so that it comes into contact with one side of said profiles;
said abutments are each joined to a jaw of said clamp;
said abutment is retractable and is adapted so that it can be moved to a retracted position in which it no longer immobilises the said profiles when said slider is in position thereupon.

Another aspect of the invention concerns a method for placing a slider on a bag with mating closure profiles, this slider comprising a base, two flanges and means adapted respectively to urge said closure profiles to draw together or to draw away from each other depending upon the direction of travel of the slider along the profiles, to move said profiles between an engaged closed position and a separated open position, by means of clamps, a method which comprises the steps of:

a) opening the jaws of each clamp and engaging therein the edge of the bag provided with mating profiles;

b) clamping the jaws to immobilise the bag;

c) pushing said slider in the direction of the bag so that the flanges thereof are gradually drawn apart in order to engage the slider on the profiles, then gradually drawing together the flanges to lock the slider on the said profiles.

According to the invention, this method is noteworthy in the fact that at step c):
the flanges of said slider are gradually drawn apart by means of retractable cams which, in a first non-retracted position, interact with the said slider so that as it moves the inner face of its flanges comes into contact with the cam paths with rising slope carried by these cams so as gradually to draw them away from each other;
the flanges are then drawn towards each other by moving said cams to a second retracted position in which the inner face of the flanges is no longer in contact with the cam paths with rising slope;
the changeover from the first to the second position taking place by contact of the base of the said slider with the said cams during the movement of the said slider.

According to one particular embodiment of this method, cams with pivot axis are used, the changeover from the first to the second position occurring by pivoting around this axis.

Advantageously, the cams used have one bevelled face, the changeover from the first to the second position taking place by wedge effect when the said base of the slider comes into contact with this bevelled face.

Other characteristics and advantages of the present invention will become apparent on reading the following detailed description of a preferred embodiment.

This description is made with reference to the appended drawings in which:

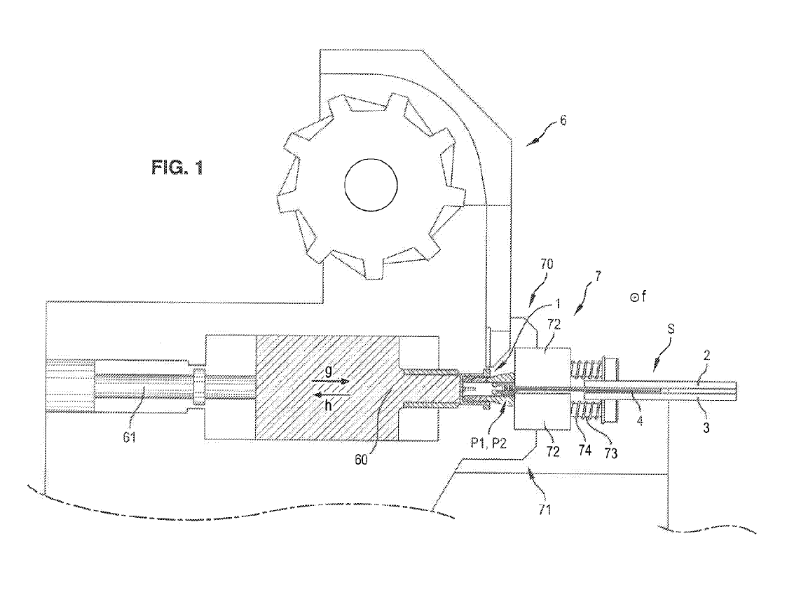

FIG. 1 is a partial, simplified view along a longitudinal and vertical median sectional plane of a device conforming to the invention;

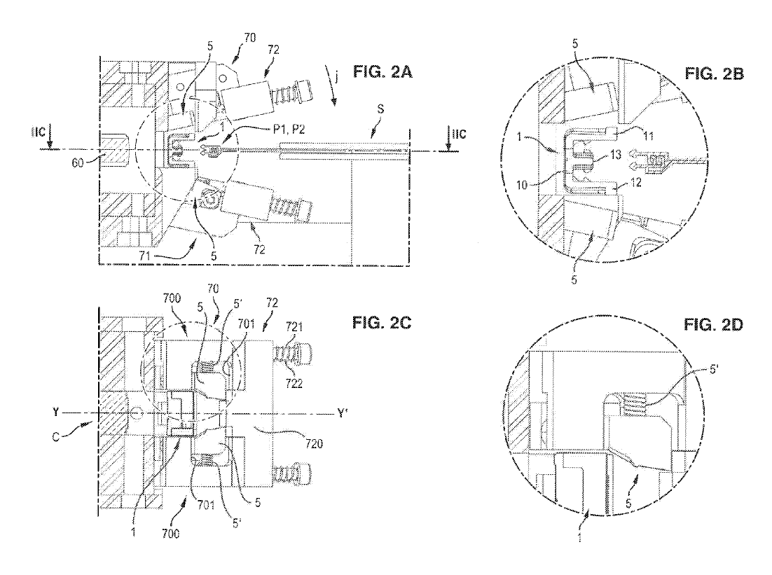

FIGS. 2A to 7A are partial views of the device in FIG. 1, intended to illustrate different steps of the method according to the invention,

FIGS. 2B to 7B are magnified views of the corresponding regions in FIGS. 2A to 7A, identified by a circle;

FIGS. 2C to 7C are similar views to FIGS. 2A to 7A as cut by the plane indicated in these latter figures;

FIGS. 2D to 7D are magnified views of the corresponding regions in FIGS. 2C to 7C, identified by a circle;

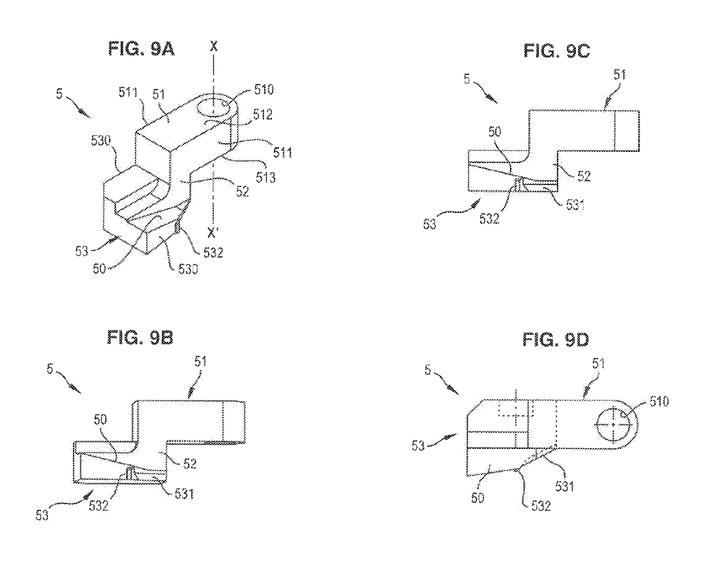

FIGS. 9A and 9B are perspective views of a cam of the above-mentioned device;

FIGS. 9C and 9D are side and overhead views of this cam;

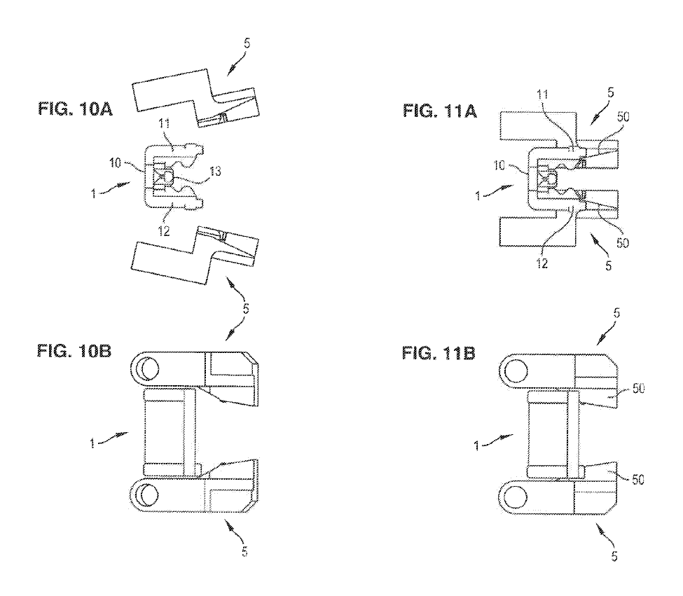

FIGS. 10A to 14A are simplified side views of a slider and associated cams, in different positions illustrating the main steps of the method;

FIGS. 10B to 14B are similar to FIGS. 10A to 14A, the sliders and cams being shown this time from overhead.

The device for placing a slider, such as chiefly illustrated FIG. 1 and in the other appended figures, is a device of generally known type for mounting a slider on bags with mating closure profiles.

For example the general structure of said device is described in document FR-A-2076728.

In the example of embodiment described herein, the device illustrates the positioning of a slider 1 on a bag S provided with mating profiles P₁, P₂.

As illustrated in FIG. 1, each profile P₁, P₂ of generally known structure is carried by a strip 4 (or is an integral part of said strip). These two strips are both respectively attached to the inner face of two films 2 and 3 forming the large sides of the bag 3 to be equipped.

This description evidently applies also to the positioning of a slider on profiles P₁, P₂ not yet associated with a bag. In said hypothesis, the attaching of the profiles to the bags is conducted at a later stage.

The bag is part of a continuous web of bags (not illustrated) which is moved step-by-step so that each in turn is equipped with a slider. The direction of travel of this web of adjacent bags is illustrated by the arrow f in FIG. 1.

In manner known per se, the device 6 comprises a pair of clamps 7 having parallel movement, the upper jaw thereof being referenced 70 whilst the lower jaw is referenced 71.

Each jaw, to some extent, is composed of two parallel semi-jaws joined to each other.

Therefore if reference is made to FIG. 2C, it is ascertained that the upper jaw 70 is formed of two semi-jaws 700 which are the image of each other relative to a longitudinal axis Y-Y′ perpendicular to the travel axis of the bag S.

The same applies to the lower jaw 71 which is the reverse image of jaw 70.

The two semi-jaws of each jaw are separated from each other by a channel C identified in FIG. 2C having an axis Y-Y′.

In manner known per se, this device comprises means, not illustrated, for the feeding of sliders 1. These sliders may be bulk packed and distributed by a vibrating feeder with loading magazine, or they may be arranged in a line one after the other.

Evidently, and in accordance with the known state of the art as described in the above-cited document for example, said device comprises slider feed means whose functioning is controlled by the functioning of its other constituent members and in particular by those which allow the mounting of said slider on the profiles.

As can be seen in particular in FIG. 1, the device is provided with a double-acting cylinder 61 in which the free end of the rod carries a piston 60 or linear actuator.

This piston is capable of sliding in predetermined travel sequences inside the above-mentioned channel C, along the axis Y-Y′. Ahead of this piston there is a space, not illustrated, for receiving a new slider 1 to be placed in position.

The back and forward movements of the piston are referenced by arrows g and h in FIG. 1.

With particular reference to FIG. 2C, it can be seen that the two semi-jaws 700 of the upper jaw 70 (and similarly for the lower jaw 71) comprise a cavity 701 arranged transversally whose opening opens opposite the second semi-jaw.

Inside each cavity 701 there is arranged a retractable cam 5 whose structure and function is explained below.

Still with reference to this figure, it can be seen that the space between the two semi-jaws 700, to within clearance, is very slightly larger than the length of the slider 1 to be placed in position.

It will also be ascertained that the free ends of the two upper semi-jaws 700 (and of the two lower semi-jaws) are connected by an abutment 72 which comprises a nose 720 extending inside the aforementioned channel C.

This is a retractable abutment, this abutment being slidingly mounted on rods 721 on which helical springs 722 are press-fitted. These springs tend to return the abutment 720 to its position illustrated FIG. 2C in which the nose 720 is engaged inside the channel C.

Reference will now be made to FIGS. 9A to 9D to describe the aforementioned retractable cams.

As indicated above, each semi-jaw is equipped with a cam 5. They are all identical and mounted so that they are the mirror image of each other.

Therefore a description of only one thereof will be given, this description applying to the others.

The cam 5 under consideration can be seen in perspective in FIG. 9A.

It comprises an upper body 51, a lower body 53 and an intermediate portion 52.

The upper body 51 lies substantially within a rectangular parallelepiped whose upper and lower faces are referenced 512 and 513.

Its large side faces 511 extend longitudinally i.e. parallel to the aforementioned axis Y-Y′ when the cam is in the first non-retracted position.

A cylindrical through-hole 510 provides communication between the upper face 512 and lower face 513 of the cam.

The axis of this orifice is referenced X-X′. A rotating shaft is press-fitted therein so that it is possible to cause the cam to undergo a rotational movement relative to this axis.

The upper body 51 is continued on the side of its lower face 513 by an intermediate portion 52 which imparts a stepped profile thereto.

This intermediate portion connects to a lower body 53 which partly extends in the continuation of the upper body.

This lower body comprises two longitudinal faces 530 whose mutual separating distance is greater than the distance between the faces 511 of the upper body.

It will be noted however that one of the faces 530 extends over the same plane as the face 511 arranged on the same side.

On the opposite side, the lower body therefore projects laterally to form on its upper face a rising slope cam path 50, this rising slope originating on the side of the upper body 51 in the direction of the free end of the lower body 53.

Also, it can be seen that the longitudinal face 530 which borders the aforementioned cam path 50 connects to the intermediate portion 52 via a bevelled portion 531 whose function is explained below.

The aforementioned face 530 connects to the bevelled portion 531 via a lug 532.

These cams 5 are mounted in the device so that the lower body 53 is engaged in the aforementioned cavities 701.

Helical springs 5′ are mounted in these cavities and bear upon the face 530 opposite the cam path 50, tending to place demand thereupon so that the body 53 projects from the cavity 701.

More precisely, the cam paths 50 and the bevelled portion 531, as shown FIG. 2C, extend inside the channel C when the cams 5 take up their first non-retracted position.

Evidently, the cavity 701 is conformed also to receive the upper body 51 and its associated pivot axis.

With reference to FIGS. 2A to 8D and also to FIGS. 10A to 14B, a description will now be given of the manner in which a slider is placed on the mating profiles P₁, P₂ such as those illustrated FIG. 1.

The slider concerned is particularly visible in FIG. 2B.

It is a slider 1 in plastic of usual type which comprises a base 10 and two parallel flanges 11 and 12 and means 13 which extend parallel to the flanges 11 and 12 from the base 10 and which are adapted to urge the closure profiles P₁, P₂ respectively to draw together or to draw apart depending on the direction of travel of the slider along these profiles.

In manner known per se, the flanges 11 and 12 have sufficient elasticity so that they can be drawn apart to allow the profiles P₁, P₂ to be positioned inside corridors which are delimited by the means 13 and the two flanges 11 and 12.

The method of the invention comprises the following steps.

At a preliminary step which corresponds to FIGS. 2A to 2D and to FIGS. 10A and 10D, the jaws 70 and 71 of the clamp 7 are drawn away from each other in open position.

Mechanized means, conveying a web of bags to be equipped with sliders, position one bag and immobilise it level with said clamp as shown FIG. 2A. At the same time, a slider 1 is brought inside the device, inside the channel C by means not illustrated.

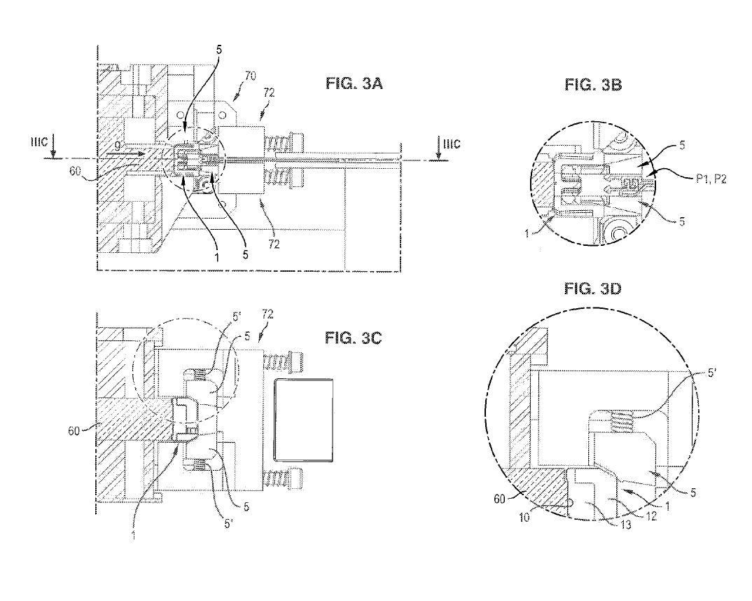

At the next step, illustrated FIGS. 3A to 3D and 11A and 11B, the jaws 70 and 71 are closed over the profiles P₁, P₂.

The mobile abutments 72 are arranged so as to clamp these profiles tightly against each other and, being constantly urged by the springs with which they are equipped, they oppose any undue movement thereof in the direction of the arrow g, i.e. in a direction which would distance them away from the slider 1.

The piston or linear actuator 60 of the cylinder is then gradually moved in the direction of the arrow g so that it comes to bear against the base 10 of the slider to push it in the direction of the profiles P₁ and P₂.

During this movement, the adequately arranged cams 5 gradually enter inside the slider 1 so that the cam paths 50 come into contact with the inner faces of the flanges 11 and 12 of the slider.

It will therefore be understood that as and when this movement takes place, the flanges 11 and 12 will draw away from each other so as to release sufficient space between themselves and the means 13 to allow the engaging of the profiles P₁, P₂.

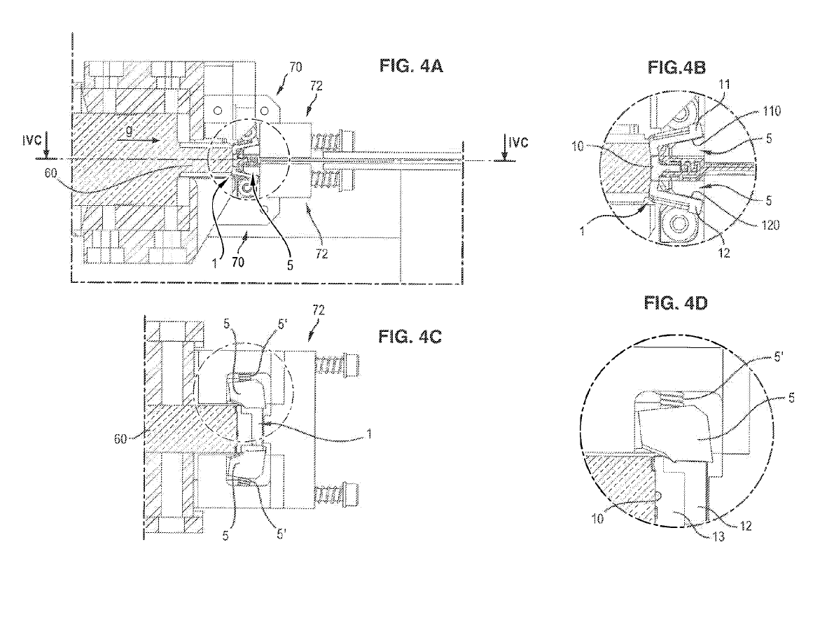

After a certain travel distance, which corresponds to the step which can be seen FIGS. 4A to 4D and in FIGS. 12A and 12B, the hooks of the profiles P₁, P₂ come to abut inside corridors delimited by the flanges 11 and 12, and the means 13.

In addition, the base 10 of the slider comes into contact with the retractable cams 5.

This contact is made at the bevelled face 531 which, by wedge effect, causes rotation of the cams around the axis X-X′ so that they gradually move inside the cavities 701.

At this step, the cams 5 are still partly engaged in the slider with the result that the slider flanges continue to be drawn apart.

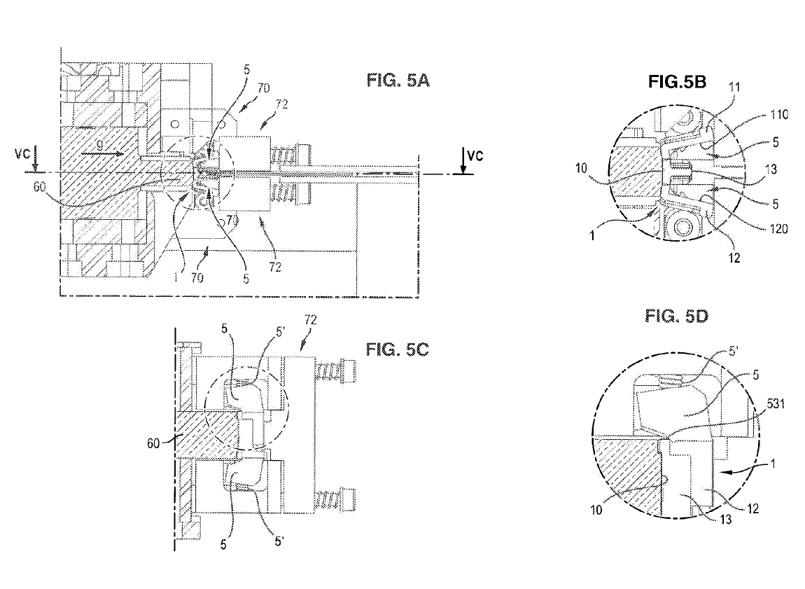

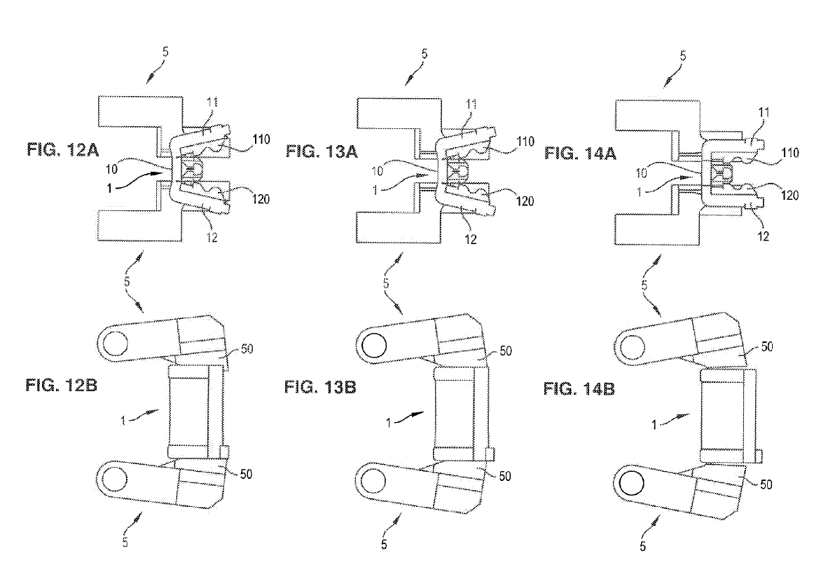

At a following step which corresponds to FIGS. 5A to 5D and 13A and 13B, the piston 60 continues to cause the slider 1 to move forward.

Under the effect of this forward movement, the mobile abutments 72 move back against the springs with which they are equipped, whilst maintaining a counter-pressure on the profiles which contributes towards the insertion of the end of these profiles inside the slider.

Under the action of the movement of the base of the slider, the cams 5 continue their rotation so that they remain inside the slider 1 whose flanges continue to draw away from each other.

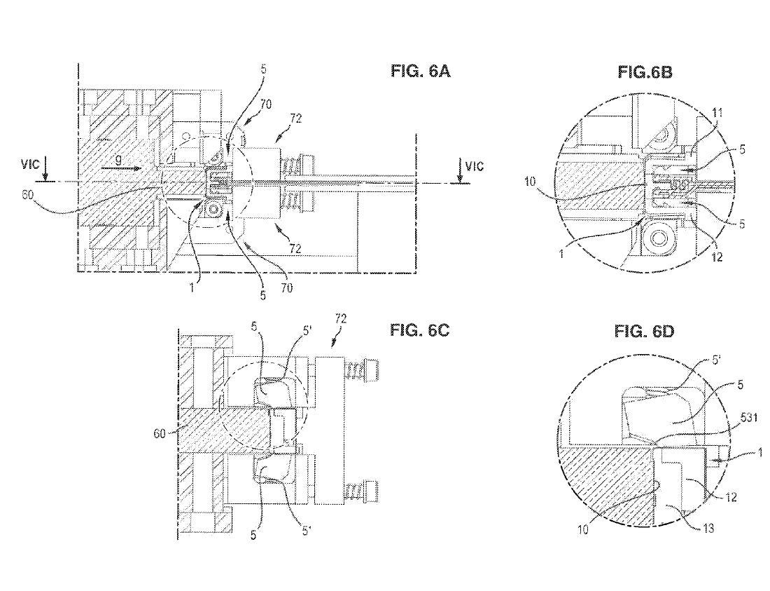

At a subsequent step illustrated FIGS. 6A to 6D and 14A and 14B, the piston 60 is in maximum forward position and therefore has continued to move the slider in the direction of the arrow g.

Under the action of the base 10 of the slider, the cams 5 continue their rotation against the springs 5′ and when the base 10 of the slider has reached the lugs 532 of the cams 5, the cams retract fully inside the cavities 701 so that they move out of the slider 1, the result being that the flanges 11 and 12 close over the profiles P₁, P₂.

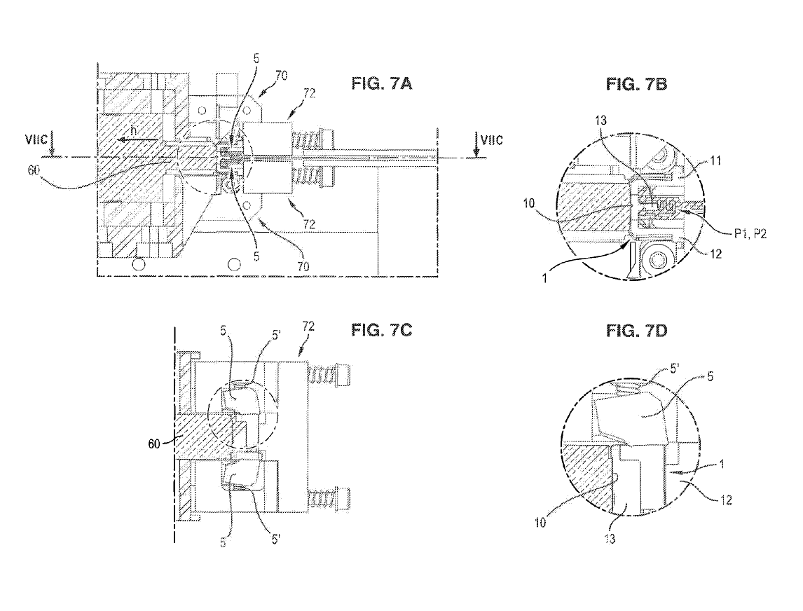

At the following step, illustrated FIGS. 7A to 7D, the piston 60 is guided so that it moves back in the direction of arrow h under the effect of the force exerted on the profiles P₁, P₂ by the mobile abutments 72. The slider 1, press-fitted onto the profiles P₁, P₂, also moves backwards.

The side faces of the cams 5 are then in contact with the outer side faces of the slider 1 so that only the lugs 532 are slightly inserted inside the slider.

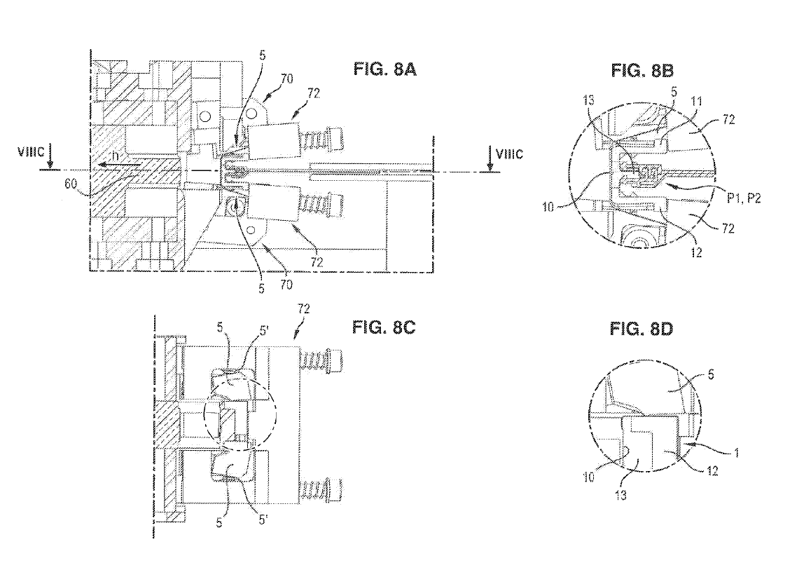

At the following step illustrated FIGS. 8A to 8D, the jaws 70 and 71 of the clamp open to release the web of bags of which one bag has just been equipped with a slider.

At the time of opening of these jaws, and by means of the inclined face of the cams 5, these cams are drawn slightly aside on account of their axis of rotation and move fully outside the slider without opening it.

It is therefore possible to allow the web of bags to move forward by one pitch for the mounting of a new slider.

1. A device for mounting a slider (1) to actuate closure profiles (P₁, P₂), in particular for a closure assembly equipping a bag (S), which comprises a base (10), two flanges (11,12) and means (13) adapted to urge the said closure profiles (P₁, P₂) respectively to draw together or to draw apart depending on the direction of travel of the slider along the profiles (P₁, P₂), to move the profiles (P₁, P₂) between an engaged closed position and a separated open position, on a bag (S) with mating closure profiles (P₁, P₂) or on an assembly of mating closure profiles (P₁, P₂), this device comprising at least one retaining clamp (7) to hold the profiles (P₁, P₂) in stable position, and means to push a slider (1) towards means (5) for provisionally drawing apart said flanges (11, 12) of the slider (1) for the purpose of causing it to cooperate with the said profiles (P₁, P₂) in stable position, these drawing-apart means comprising cam paths (50) with rising slope, characterized by the fact that the said means are composed of retractable cams (5) which, in a first non-retracted position, interact with said slider (1) so that during the travel thereof the inner face (110, 120) of its flanges (11, 12) comes into contact with the cam paths (50) to draw them gradually away from each other and which, in a second retracted position, no longer interact with the said slider (1) so that the said flanges (11, 12) draw close to one another, the changeover from the first to the second position taking place by contact of the base (10) of said slider (1) with the said cams (5), during the movement of said slider (1).

2. The device according to claim 1, wherein the said cams (5) are cams with a pivot axis (X-X′), the changeover from the first to the second position occurring by pivoting around this axis (X-X′).

3. The device according to claim 2, wherein the said axis (X-X′) extends over a plane generally parallel to the plane in which the base (10) of said slider (1) is contained.

4. The device according to one of claim 1 or 2, wherein it comprises retaining means (5′) to hold said cams (5) in said first position, which holds them in this position for as long as the base (10) of the slider (1) is not in contact therewith.

5. The device according to claim 4, wherein said retaining means (5′) are composed of springs.

6. The device according to claim 2, wherein said cams (5) have a bevelled face (531), the changeover from the first to the second position occurring by wedge effect, when said base (10) of the slider (1) comes into contact with this bevelled face (531).

7. The device according to claim 1, wherein said device it comprises two pairs of cams (5), each pair being positioned to come into contact with one same flange (11, 12) of the said slider (1).

8. The device according to claim 7, wherein said pairs (5) are separated by a space for positioning said profiles (P₁, P₂).

9. The device according to claim 8, wherein it comprises at least one abutment (2) for immobilising said profiles (P₁, Pₐ).

10. The device according to claim 9, wherein it comprises a pair of abutments (72) each being positioned to come into contact with one side of said profiles (P₁, P₂).

11. The device according to claim 10, wherein said abutments (72) are each joined to a jaw (70) of said clamp (7).

12. The device according to claim 9, wherein said abutment (72) is retractable and is adapted to be moved to a retracted position in which it no longer immobilises the said profiles (P₁, P₂) when said slider (1) is in position thereupon.

13. A method for placing a slider (1) on a bag (S) with mating closure profiles (P₁, P₂), this slider (5) comprising a base (10), two flanges (11, 12) and means (13) adapted to urge the said closure profiles (P₁, P₂) respectively to draw together or to draw apart depending upon the direction of travel of the slider along the profiles (P₁, P₂), to move the profiles (P₁, P₂) between an engaged closed position and a separated open position, by means of clamps (7), a method which comprises the steps of:
a) opening the jaws (70, 71) of each clamp (7) and engaging therein the edge of the bag (S) provided with mating profiles (P₁, P₂);
b) clamping the jaws (70, 71) to immobilise the bag (S);
c) pushing the said slider (1) in the direction of the bag (S), in order progressively to draw its flanges away from each other so that it engages on the profiles, then gradually drawing the flanges towards each other to lock the slider on the said profiles,
wherein at step c):
the flanges (11, 12) of said slider (1) are gradually drawn apart by means of retractable cams (5) which, in a first non-retracted position, interact with said slider (1) so that as it moves the inner face (110, 120) of its flanges (11, 12) comes into contact with cam paths (50) with rising slope carried by these cams (5) to draw them gradually away from each other;
the said flanges (11, 12) are then drawn together by moving said cams (5) to a second retracted position in which the inner face (110, 120) of the flanges (11, 12) is no longer in contact with the cam paths (50) with rising slope;
the changeover from the first to the second position occurring by contact of the base (10) of said slider (1) with said cams (5) during the movement of the said slider (1).

14. The method according to claim 13, wherein the cams (5) used have a pivot axis (X-X′), the changeover from the first to the second position taking place by pivoting around this axis (X-X′).

15. The method according to claim 13, wherein the cams (5) used have a bevelled face (531), the changeover from the first to the second position occurring via wedge effect when said base (10) of the slider (1) comes into contact with this bevelled face (531).
